(19) United States
(12) Patent Application Publication
(10) Pub. No.: US 2012/0212318 A1
(43) Pub. Date: Aug. 23, 2012

(54) Instrument module with intelligent self-actuating latching mechanism

(76) Inventors: Eric L. Dobson, Knoxville, TN (US); Joel K. Reed, Knoxville, TN (US); Thomas L. Mann, Knoxville, TN (US); Daniel L. Blankenship, Knoxville, TN (US); Steven P. Kurant, Knoxville, TN (US)

(21) Appl. No.: 12/932,303

(22) Filed: Feb. 23, 2011

(51) Int. Cl. G05B 23/02

(52) U.S. Cl. 340/3.1

(57) ABSTRACT

An instrumented module attaches to a shipping container and preferably spans the two locking bars, preventing unauthorized opening. The module includes a means for detecting position and/or movement. The module may be latched onto one of the locking bars of the trailer while the doors are open; when the doors are closed, the module engages the corresponding bar on the opposite door to secure the trailer in transit. The manual latch keeps the module in position while the vehicle is at rest, but is not intended to keep the module in place when the truck is moving. If the module has been manually latched onto one locking bar but not the other, and the driver leaves the loading dock, the module's inherent situational awareness is used to activate the lock automatically, thereby securing the latch and keeping the module attached even if the door is unlocked and swinging freely.

### CROSS-REFERENCE TO RELATED APPLICATION

This application is related to U.S. patent application Ser. No. 12/313,428 filed on Nov. 20, 2008, and U.S. patent application Ser. No. 12/313,427 filed on Nov. 20, 2008 by the present inventors, the entire disclosures of which are incorporated herein by reference.

### BACKGROUND OF THE INVENTION

1. Field of the Invention

The invention pertains to apparatus and methods for securing devices onto vehicles, and more particularly to devices that can be securely locked onto trucks and cargo containers for tracking and other purposes.

2. Description of Related Art

The shipping industry is the life-blood of the global economy. Approximately 90 percent of all cargo moves through the Marine Transportation System (MTS). Domestic shipping via the MTS totals over $850 billion in cargo annually and contributes $2 trillion to the U.S. Gross Domestic Product. The current volume of domestic maritime shipping is expected to double over the next 20 years. International maritime shipping is expected to triple over the same time period. Yet, this system is plagued with problems of efficiency and security, which are different sides of the same coin. The solution to both problems of asset visibility and security can be solved with ruggedized intelligent locking systems as described in the applicant's co-pending applications. Due to the established processes and logistics needs of the industry, removable and reusable locking devices are required. However, these devices, sufficiently resilient and ruggedized, pose a threat to collateral life and property if incorrectly installed. In this situation, people installing and operating the device and vehicles traveling with proximity to the device are at risk if the device is inadvertently released from the container.

What is needed, therefore, is a convenient tracking and security module that may be easily installed and removed from a particular truck or cargo container, while at the same time being robust and self-aware, and able to correct for inadvertent misuse or incomplete installation.

3. Objects and Advantages

Objects of the present invention include the following: providing a manually actuated latch that is supplemented by an automatic lock for improved safety; providing a locking and tracking device having improved safety for attachment to cargo containers; providing a lock/latch mechanism that locks itself upon the detection of selected events; and, providing an instrumented module for moving vehicles that is less susceptible to accidental loss or damage. These and other objects and advantages of the invention will become apparent from consideration of the following specification, read in conjunction with the drawings.

### SUMMARY OF THE INVENTION

According to one aspect of the invention, an instrument module for attachment to a shipping container, comprises:

a substantially rigid housing containing at least one electronic instrument;

a manually operated latch mechanism to attach the module to a first bar on the shipping container;

a means of detecting movement of the container; and,

an electromechanical lock mechanism to automatically secure the manually operated latch when a selected amount of movement is detected.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIG. 1 is a schematic diagram of one embodiment of the present invention, showing a module attached to the locking bars on a shipping container.

FIG. 2 is a schematic diagram of a manual latching mechanism to attach the module to the trailer while the doors are open.

FIG. 3 is a schematic diagram of the logical operations under which an electromechanical lock may automatically secure the latch.

### DETAILED DESCRIPTION OF THE INVENTION

In Applicants' co-pending U.S. Patent Applications, various solutions are described for security and tracking of cargo, particularly in trucks and intermodal shipping containers. One element of these solutions involves an instrumented module that attaches to a shipping container and preferably spans the two locking bars, thereby preventing unauthorized access to the container between shipping and receiving points. The module is typically equipped with one or more geographic information systems to determine its location; these might include a global positioning system (GPS) as well as redundant systems such as clocks or dead reckoning methods to back up the primary location system. For the case of maritime shipping, Applicants contemplate that the module will normally be placed on the container at the point of shipping and can only be removed at the port of destination. For the case of trucking, Applicants contemplate that the module will be placed across the locking bars on a semitrailer and unlocked at various receiving or delivery points. It is therefore desirable that the module may be easily latched onto one of the locking bars of the trailer while the doors are open; then, when the doors are closed, the module engages the corresponding bar on the opposite door to secure the trailer until the next destination is reached.

The manual latch is intended strictly for keeping the module in a convenient position while the vehicle is at rest, and for quick attachment and detachment; it is not intended to be relied upon to keep the module in place when the truck is moving, particularly at highway speeds. When the module has engaged both locking bars and is activated, an electromechanical lock secures the latch mechanism with actuators common in mechanical engineering, such as screw drive, solenoid drive, etc. Applicants recognized that situations might arise in which the module has been manually latched onto one locking bar but not the other, and the driver inadvertently leaves the loading dock. In this case, to prevent the risk of the module accidentally coming loose from the bar, the present invention uses the module's inherent situational awareness to activate the lock automatically, thereby securing the latch and keeping the module attached even in the extreme case in which the door is unlocked and swinging freely.

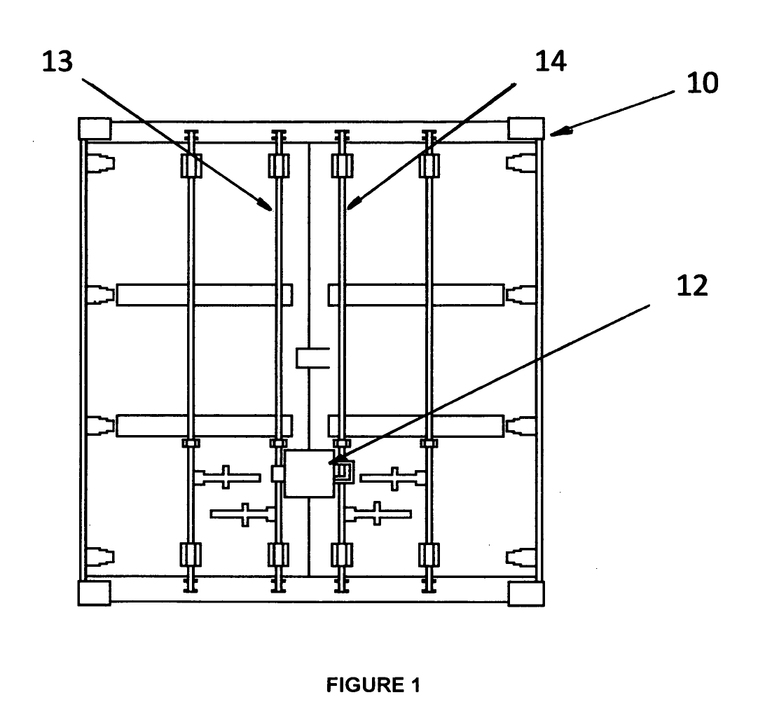

FIG. 1 illustrates a typical installation of a tracking and security module to the locking bars of a shipping container. As described in detail in Applicants' co-pending applications, the module contains various devices to perform various useful functions. These might include, for example, wireless communications technologies (including, but not limited to: Radio Frequency Identification, cellular communications, and satellite communications) and a sensor interface to allow the detection of selected events or environmental factors (including but not limited to: tilting, vibration, and tamper switches, air pressure, temperature and humidity sensors, and detectors for hazardous conditions such as the presence of chemical, biological, radiological, nuclear, and explosive agents). The module further incorporates a geographically-based lock that prevents unauthorized opening of the container until the container has reached a selected destination.

In the examples that follow, it will become apparent that a trackable, removable, and secure device to secure both doors simultaneously provides a unique solution to many of the known concerns of the intermodal shipping industry. Some of the noteworthy benefits include: 1. Only one device is required to secure both the doors. 2. Tracking the lock is a convenient proxy for tracking the container. 3. The inventive device is reusuable by shipper or carrier and because it is a small, high-value component (compared to the empty container) it is more convenient to store when not in use than a similar component integrated permanently onto a container. 4. It does not interrupt the normal flow of cargo or impede legitimate access to the cargo. 5. It allows access to be granted according to a selected hierarchy of communications and information.

### Example

Applicants' co-pending application describes a removable module configured to securely lock a shipping container. Applicants contemplate that in many applications, the module will be configured with a form factor that is compatible with certain characteristic dimensions of standard shipping containers 10, as shown in FIG. 1. Although not shown in the drawings, it will be appreciated that the inventive concept may equally well be adapted to containers of other geometries with only routine engineering modifications. Suitable applications could involve shipping containers of various sizes and form factors including: dry van trailers, refrigerated containers, man portable cases, etc.

### Example

The module 12 typically contains, among other things, a GPS circuit that operates to prevent the container 10 from being unlocked before it has reached a selected destination. The module optionally includes the provision of at least the following: one or more selected sensor packages 21; one or more wireless communication systems that may include Radio Frequency Identification, data radios, cellular, and satellite communications. A suitable antenna is preferably disposed integrally with the device to minimize protrusions and protect the system from mechanical damage. Additional RFID components may be located on the side of the device.

### Example

Although some elements of the device (notably RFID tags) may be substantially passive devices, it is contemplated that in many applications it will be preferable to have an on-board power supply 25. This may be accomplished with batteries, fuel cells, and the like, and provision may also be made for recharging or maintaining charge via a cradle or an umbilical configured to accept power from a shipboard generator during ocean transit, for example.

### Example

The sensor package 21 may include a number of devices performing various security and tracking functions. The device may allow for wireless communication with a variety of sensors (chemical, biological, radiological, nuclear, explosive, temperature, humidity, vibration, accelerometry, etc.) and information sources (camera, keypad, PDA, cell phone, satellite phone, hand-held interrogator, RFID reader, etc.). The sensor package may contain a load cell, strain gage, or other means of monitoring tension on locking bar so that an alarm condition will be triggered if the bar is cut or even if the bars on the container door are cut. The device may communicate wirelessly with a sensor node, which detects a variety of constituents and conditions, either permanently or temporarily installed in an intermodal container, over the road trailer, or enclosed conveyance.

It will be appreciated that wireless communication may include such familiar protocols as serial radio, cellular radio, satellite radio, etc. The wireless device(s) will preferably be utilized in order of cost of communications beginning with the serial radio, which, with the Reader within range, represents the least cost. Failing to identify a valid serial radio link, the cellular radio may be activated. Failing to identify a valid cellular link, satellite communication to one of multiple low earth orbit satellite systems may be activated. This process optimizes the cost of data communications on a global basis.

### Example

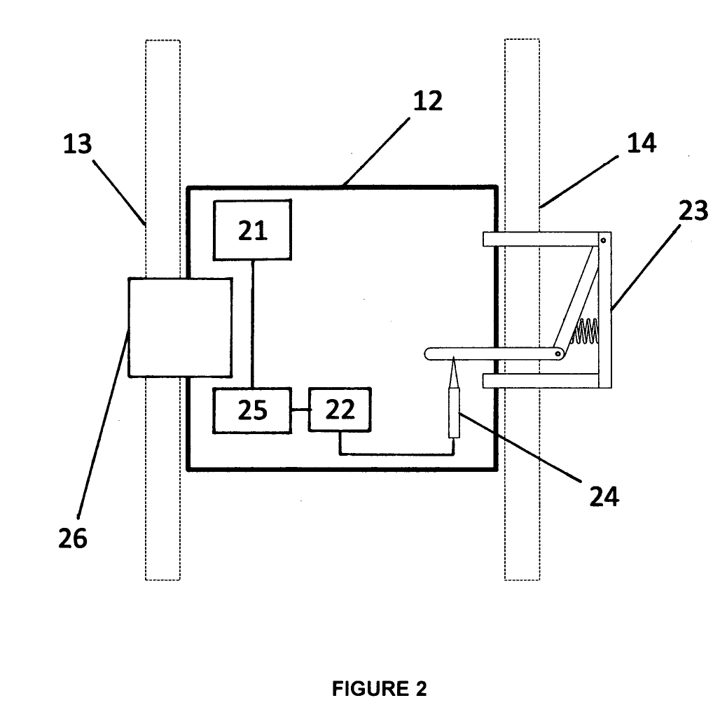

FIG. 2 illustrates a manually-operated latching mechanism, configured to engage one of the two locking bars on a semitrailer or intermodal shipping container. To operate the mechanism, the user grasps the module by its handle 23 and manually opens the latch, working against spring tension, and places the module so that the latch will engage the locking bar 14 when the manual pressure is released. The spring tension closes the latch around the bar 14, holding the module in place. This may be done while the cargo doors are open or closed. The inventive latch includes a microcontroller 22, which will drive an actuator 24 to insure a secure fit to the locking/retaining bar upon the satisfaction of at least one predetermined condition, primarily, but not limited to: violation of a geofence, change of location, speed over ground, receipt of local area wireless signals, vibration, orientation shift, impact. During normal operation, the electromechanical lock is engaged as part of the operation of locking the doors. In that case, the cargo doors are closed and the locking bars 13 and 14 are secured. Then, the module is positioned to engage the second bar and apply tension between the two locking bars. The electromechanical lock 26 is engaged and the module is programmed so that it cannot be opened until selected conditions are satisfied. Those conditions will typically include geolocation, as well as time, entry of a security code, etc. as taught in Applicants' co-pending applications.

### Example

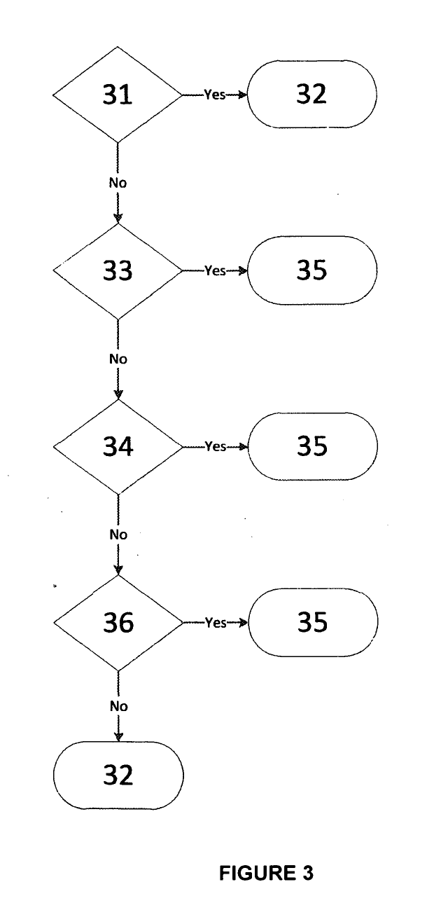

FIG. 3 shows an alternate series of steps that are taken by the invention in the case where the module has been manually engaged to the first bar but not locked, and then the driver inadvertently pulls away from the loading dock. The module 12, sensing that the vehicle is moving, independently activates the electromechanical lock 24 so that the module is now securely locked to the first bar 14 and cannot be manually removed or stolen, nor shaken loose by bumps or vibrations as the truck moves along the road. The logical sequence includes the following steps:

31 Is the module latched?

32 OK

33 Is the module locked?

34 Is the module moving, based on speed or position?

36 Is impact or vibration detected?

35 Automatically actuate latch

### Example

The device can use a combination of well-known and commercially available components, systems, and/or services to determine location, speed, orientation, and direction of travel, as well as impact and vibration. GPS modules, such as the Fastrax 500 series, combine high sensitivity, multichannel receivers with Assisted GPS to provide precise location data at commercially viable price points. Cellular modems, such as the Telit 300 series, with quad-band GSM/GPRS transceivers, can provide the network data necessary for Assisted GPS, as well as Cell ID information that can be used by network providers, such as AT&T, or by some other Application Programming Interface (such as Google) to augment the position data in high interference areas. Solid state accelerometers, such as Analog Devices' ADXL345, can provide additional data points for speed and direction, as well as impact, vibration, and orientation.

With this wealth of position and status data, the on-board microprocessor 22 can be programmed to automatically secure the latch mechanism under a wide variety of conditions such as:

1. Speed over ground greater than a selected threshold value

2. Location indicates leaving a predefined area

3. Impact/vibration in a given axis greater than a selected threshold value

As noted earlier, the inventive module may contain various features to enhance aspects of situational awareness beyond simple geolocation via GPS or some other triangulation methods. The invention may therefore exploit information from these other sources, either as a supplement to geolocation or as a substitute therefor, as described in more detail in the following examples.

### Example

Applicants contemplate that in many cases, the inventive module will contain an onboard clock circuit. The module may therefore be programmed so that the electromechanical lock will automatically engage if a preset time has elapsed after manually latching it onto the first locking bar, if it has not been locked onto the second bar.

### Example

The inventive module may contain accelerometers, as part of a dead-reckoning system or to detect shock or impacts to the cargo. Information from these sensors may also be exploited to detect that the container is in motion and automatically activate the electromechanical lock.

### Example

The inventive module is contemplated to be a part of a communication network that allows users to view the location and status of assets during shipment, often in real time. The module is therefore equipped to communicate various aspects of its location and condition to a centrally located server system. The module may thus be programmed to report the fact that is has detected movement in an unlocked state and has autonomously activated its electromechanical lock. This information might be used to alert the system monitor that an off-normal situation exists and various actions should be taken. One such action, for example, would be to call the driver of the vehicle or his dispatcher, and alert them that the module has not been properly installed, that the vehicle appears to be moving without properly locked doors, and that immediate action is needed to stop and secure the locks correctly.

From the foregoing, it will be appreciated that the invention provides a greater degree of safety and security, by allowing the module to autonomously lock itself securely onto a moving container, after possibly improper installation, and to notify users that corrective actions are indicated.

We claim:

1. An instrument module for attachment to a shipping container, comprising:
a substantially rigid housing containing at least one electronic instrument;
a manually operated latch mechanism to attach said module to a first bar on said shipping container;
a means of detecting movement of said container; and,
an electromechanical lock mechanism to automatically secure said manually operated latch when a selected amount of said movement is detected.

2. The instrument module of claim 1 wherein said at least one electronic instrument is selected from the group consisting of: clocks; wireless communication devices; physical and chemical sensors; and geographic information systems.

3. The instrument module of claim 1 wherein said manually operated latch mechanism comprises a hand-operated, spring-loaded clasping device sufficient to hold said module onto said first bar on said shipping container while said shipping container is stationary.

4. The instrument module of claim 1 wherein said means of detecting movement of said container is selected from the following group: determining a change in geographic location; determining that said container is moving at a selected speed; detecting vibration above a selected level; and determining that a selected time has elapsed since said manually operated latch was applied.

5. The instrument module of claim 1 further comprising a second locking mechanism to attach said module to a second bar on said shipping container so that said module, once locked, prevents said shipping container from being opened.
